(19) United States
(12) Patent Application Publication
(10) Pub. No.: US 2005/0035592 A1
(43) Pub. Date: Feb. 17, 2005

(54) Smooth flow pipe connector for lawn sprinkler system

(76) Inventor: Larry Franklin Williams, Madera, CA (US)

Correspondence Address: Donald W. Meeker;Patent Agent, 924 East Ocean Front #E, Newport Beach, CA, 92661, US

(21) Appl. No.: 10/913,816

(22) Filed: Aug. 6, 2004

Related U.S. Application Data
(60) Provisional application No. 60/492,657, filed on Aug. 6, 2003.

(51) Int. Cl. F16L 39/00

(52) U.S. Cl. 285/125.1; 285/179; 285/131.1

(57) ABSTRACT

A PVC pipe connector for underground sprinkler systems has one or more curved sections with a long low angled curve conducive to smooth laminar flow. The smooth flow curved section is incorporated in stretched elbow, curved Y, and curved T pipe connectors.

### CLAIM OF PROVISIONAL APPLICATION RIGHTS

This application claims the benefit of U.S. Provisional Patent Application No. 60/492,657, filed on Aug. 6, 2003.

### BACKGROUND OF THE INVENTION

1. Field of the Invention

The present invention relates to lawn sprinkler systems and particularly to a smooth flow stretched elbow pipe connector, curved Y-shaped pipe connector and curved T-shaped pipe connector all having gradual longer and smoother turns between intersecting sections of straight pipe in an underground sprinkler system for less resistance to the flow of water.

2. Description of the Prior Art

In the past, conventional irrigation sprinkler systems have been employed wherein a plurality of individual irrigation sprinkler heads or units are connected with a water supply line in order to provide irrigation water to a selected terrain area. Fluid transfer systems such as those used for underground lawn sprinkler systems are typically are constructed of rigid polyvinyl chloride (PVC) pipe. PVC lawn sprinkler systems must be assembled using different fittings or connectors, such as elbows and tees, to connect straight pipes laid in different directions.

Normally, the PVC lawn sprinkler pipes are laid underground in four inch wide trenches with pipe sizes from half an inch to one-and-a-half or two inches with the pipe centered in the trenches. The trenches are normally cut straight in a grid pattern with 90 degree bends between the intersecting trenches.

With a regular 90 degree elbow connector or a regular tee connector, because of the sharp bend in the connectors, the water hits a dead end and is forced into another direction, which causes resistance and loss of water pressure in the system. In pump driven systems using water from a well or underground aquifers, a lower water pressure requires longer watering time.

In an attempt to create a smoother flow using 45 degree elbows, two pieces would have to be glued together with a straight pipe as a connector for both 45's. That means buying two 45 degree elbows and a straight section of pipe and connecting all three pieces. This requires more time and more money and still does not provide maximum pressure and the most efficient water flow.

Some sprinkler installations have so many lines or stations to run they have to run their clock 10 hours a day: that means they have to run their water when electricity costs more. The long running time uses more water and causes more wear on the equipment.

The prior art does not address the problem in a cost efficient way that conserves water and reduces wear on pumps and equipment.

U.S. Pat. No. 1,855,647, issued Apr. 26, 1932 to Pottenger, Jr., is for a sprinkling system having sprinkler heads for lawns or other vegetation. The sprinkler system has a watertight housing with a mechanism for varying the water pressure to the sprinkler heads.

U.S. Pat. No. 6,386,464, issued May 14, 2002 to Watson, Sr., describes an apparatus for irrigating lawn and garden areas. Buried below ground level are a pop-up sprinkler and a housing chamber. The underground pop-up sprinkler has a bottom inlet with a female fitting mechanism affixed therein. Concentrically positioned within the housing chamber is an inner pipe member with a female fitting mechanism affixed within the opened bottom of the inner pipe member. Interconnecting the pop-up to the housing is a U-shaped second pipe member having two legs with male fitting mechanism affixed to the upper end of each leg. The male fitting mechanism of the first leg is securely attached to the female fitting mechanism of the pop-up sprinkler. The male fitting mechanism of the second leg is securely attached to the female fitting mechanism attached to the bottom of the inner pipe member situated within the housing chamber.

U.S. Pat. No. 5,947,386, issued Sep. 7, 1999 to Dick, discloses an in-ground sprinkler with an integral yet separated and locatable surface hose quick-connection. A sprinkler is provided which includes an in-ground sprinkler head connected to a surface connector. The surface connector includes a semi-flexible tube connected to curved pipe fittings and ending on the top with a quick-connect device attached to a swiveling mechanism to allow easy connection and disconnection from a garden hose of any in-ground sprinkler head. The bottom end of the connector has a male pipe fitting that connects to any type of in-ground sprinkler head. The top of the connector is a male quick-connect device attached to allow full swiveling motion to permit the quick connect device to be stored in a position at or below ground level or to be raised above ground level to connect to a hose. Flexible tubing of various lengths permits the swiveling quick-connect mechanism to be located near the sprinkler head or at other places convenient for connection to the garden hose or the accommodation of various sizes of sprinkler heads or both and provides a way to absorb the force of connecting and disconnecting a hose without disturbing the position of the sprinkler.

U.S. Pat. No. 6,003,783, issued Dec. 21, 1999 to Hunter, provides an irrigation system, apparatus, and method. The system features a pair of lines placed generally parallel and proximate to each other in the subsurface. Only one of the lines is directly connected to the water source. The other line serves as an auxiliary to permit the system to be flexibly adapted or expanded to meet changing irrigation demands or landscape conditions. The auxiliary line is separated into discrete segments, each segment pertaining to a selected zone or area to be separately irrigated. Feeder lines run from each discrete segment to sprinklers. Water is provided to the segments via valved bridges extending from the main line to the segment, so that water flows to the segments only by way of the bridges, the bridges permitting separate segments to be activated in a planned manner. The system using dual lines selectively connected by valved bridges at selected points permits the system to be expanded or adapted by the provision of additional separate segments in the auxiliary line connected to the main line by a bridge. The two lines ideally are made from polyethylene, permitting rapid and inexpensive installation of the system. Various tools customized for easy installation of the system are disclosed.

U.S. Pat. No. 5,234,163, issued Aug. 10, 1993 to Fritz, shows a power and cost saving irrigation method and apparatus, which comprises an irrigation system for irrigating an area having a pipe for delivering water to the area to be irrigated, and a pump connected to the pipe for delivering a first water supply to the pipe. A timer is operatively associated with the pump for activating the pump during a first predetermined time period. A second water supply is provided connectable to the pipe during a second predetermined time period when the pump is deactivated. A method for irrigating an area is also provided comprising the steps of: providing a water delivering pipe associated with the area for irrigating the area; delivering a first water supply to the pipe during a first predetermined time period; preventing delivery of the first water supply to the pipe during a second predetermined time period; and delivering a second water supply to the pipe during a second predetermined time period.

U.S. Pat. No. 4,462,545, issued Jul. 31, 1984 to Lourenco, claims a sprinkler device that comprises a discrete device attachable to a rotary sprinkler head for varying the water pressure therein to constrain the water distribution to produce a desired irrigation pattern. The sprinkler head attachment-device includes a housing having an intermediate wall partitioning the housing into upper and lower water chambers with an orifice therebetween. A spindle having a cam rotatable with the sprinkler head is mounted within the upper chamber. A cam follower is pivoted into engagement with the cam by means of hydraulic pressure. A valve key portion of the cam follower constricts the flow of water through the orifice in a variable manner controlled by the shape of the cam whereby the desired spray pattern is achieved.

U.S. Pat. No. 3,964,685, issued Jun. 22, 1976 to Chauvigne, indicates a lawn sprinkling installation that has a series of dosing valves arranged in cascade to each successively deliver a set quantity of water to a sprinkler. Each dosing valve has a hinged clapper biased to normally open a first outlet leading to the sprinkler and close a second outlet connected to the inlet of the successive dosing valve. Volumetric dosing means hold each clapper to close the first outlet and open the second after delivery of a regulated quantity of water and hold the clapper as long as the water pressure is maintained. When the last dosing valve shuts off supply to the last sprinkler, a gate valve supplying the first dosing valve is automatically or manually closed to allow water in the pipes joining the dosing valves to drain through a discharge orifice, thus enabling automatic resetting of the clappers.

U.S. Pat. No. 6,164,706, issued Dec. 26, 2000 to Hayes, Jr., puts forth a molded sweep elbow tube connector that comprises a first linear tube end portion, a second linear tube end portion, and a curved sweep tube portion defined by a relatively large sweep radius and joining the two end portions to form an integral one-piece molded part. The tube connector member forms an interior passageway for carrying a flow of fluid, characterized by a sweep bend between the two end portions, permitting fluid laminar flow through the tube connector. The tube connector member has a thick wall thickness over at least a portion of the curved sweep tube portion and a thin wall thickness over the first linear tube end. The thin wall thickness facilitates the removal of a curved core pin from the part through a linear tube end portion after injection molding, since the plastic material will flex enough to permit the pin to be stripped without damaging the part. The tube connector has a first connector structure at the first tube end portion, and a second connector structure at the second tube end portion. Exemplary connector structures include male and female flare connectors, and male pipe thread connectors.

U.S. Pat. No. 5,597,185, issued Jan. 28, 1997 to Bray, concerns a one piece tubular elbow fitting and process of manufacture. The fitting comprises a unitary conduit body that includes continuous, generally cylindrical side walls having a seamless configuration characterized by an absence of bumps and grooves at an inner surface thereof. The side walls are curved in an axial direction to define a flow channel having an axially arcuate flowpath and a generally circular cross section. The molecular structure of the conduit body includes former non-crystalline portions which have been reoriented and aligned to form stronger, crystalline molecular structure.

U.S. Pat. No. 3,752,438, issued Aug. 14, 1973 to Baillie, illustrates a sweep-type pipe elbow with an integral female socket joint that is formed on an internal mold.

What is needed is smoother flow and lower resistance connectors for intersecting straight pipes in an underground pipe network laid in trenches for a sprinkler system.

### SUMMARY OF THE INVENTION

An object of the present invention is to provide wider angled, longer curved, smoother flow and lower resistance connectors for intersecting straight pipes in an underground pipe network laid in trenches for a sprinkler system.

In brief, the smooth flow sprinkler PVC water pipe connectors of the present invention are all made on the concept of the natural smooth laminar flow of water when changing pipe direction, giving the highest water pressure possible rather than the forced flow of water around sharp corners using existing connectors, which causes resistance and friction and producing lower water pressure in the line.

In the current underground sprinkler systems the digging equipment and the sprinkler systems are set up to use four inch trenches in a grid pattern with straight trenches intersecting at right angles. In order to optimize the flow of water through a system with intersecting straight pipes, the present invention utilizes connectors which are fabricated with the longest and smoothest possible curved sections to fit in the center of four-inch trenches intersecting at right angles. Rather than using a short connector with a minimum circular radius bend, the present invention utilizes connectors with the bend stretched out to a maximum length of curve to fit between two four-inch perpendicular trenches with the straight pipes and the connectors positioned in the center of the trenches.

The longer curve connectors of the present invention permit a smooth laminar flow around corners to maintain high water pressure and faster flowing water is the system to deliver more water in less time than systems using existing connectors. It is the same principle as that used in road systems. A right angle corner slows down the traffic turning the corner, whereas a longer curve ramp, such as those used in entering and exiting high speed roads allow traffic to flow at a much faster speed than the sharp right angle curve at normal street intersections. The existing short circular curved connectors are similar to the sharp right angle intersecting road way with a minimal distance of turning requiring a slowing down of the water within the pipes due to the abrupt change of heading almost straight into the intersecting pipe. The smooth flow connectors of the present invention work more like an on-ramp to a high speed road, the longer arched curve of the present invention enables the water to flow smoothly from one pipe to an intersecting pipe, not interrupting flow so the water flows faster and maintains higher water pressure in the system requiring less powerful pumps and enabling more water to flow through a system even thought there might be low water pressure, as in systems using water from a well or underground aquifer.

The smooth flow sprinkler water pipe connectors of the present invention, made out of Schedule 40 PVC, will in some instances replace the regular 45 or 90 degree elbows and T and Y connectors currently being used in lawn sprinkler systems, especially coming out of the valves and on corners. In replacing old connectors with the smooth flow connectors of the present invention, a higher water pressure is maintained throughout the system delivering more water in a given time at a higher pressure which sprays out of the sprinkler at a stronger rate covering more ground with water in less time, thereby enabling a shorter watering time and reducing the number of sprinkler heads required.

One smooth laminar flow connector of the present invention is more efficient and less work to install than using two forty-five degree connectors with a straight pipe section in-between and also fits more cleanly in the intersecting four inch trenches.

The smooth flow sprinkler water pipe connectors of the present invention do not hit a dead end, but they curve allowing the water to flow with a smooth laminar flow when changing the direction of the pipe so that they maintain the highest water pressure possible. This means less resistance and friction, also. Without loss of water pressure, more sprinklers can be attached to the line, or cut down the amount of time used to water because of increased pressure.

The smooth flow sprinkler water pipe Y connector of the present invention uses the same concept as the elbow. The Y connector of the present invention instead of hitting a dead end, allows the water to naturally flow in a smooth laminar flow in both directions feeding into the connecting pipes, giving it the highest pressure possible.

The smooth flow sprinkler water pipe T connector of the present invention works with the same concept as the elbow and Y connectors of the present invention. The T connector can curve to the left or to the right as well as still going straight. The water flow moves naturally through the curve in the T connector of the present invention, providing the highest water pressure possible, whereas with the regular T currently in use, water hits a dead end, causing loss of water pressure.

The smooth flow sprinkler water pipe connectors of the present invention are a vast improvement on what is currently used in lawn sprinkler systems. They would be used with from half inch to one-and-a-half and two inch PVC pipe normally used in underground lawn sprinkler pipe systems.

The sprinkler water pipe connectors of the present invention provide the following improvements over what is currently in use:

1. Truest curve for water flow with a laminar flow throughout the system.

2. More water in less time.

3. Less electricity to pump water, saving electricity (money) and wear on pump.

4. Highest possible water pressure.

5. Can add more sprinkler heads to one existing line due to higher pressure to cover more ground over a greater distance or reduce the number of sprinkler heads to cover the same ground due to the broader spread of water from each sprinkler due to the higher pressure in the system.

The smooth flow sprinkler water pipe connectors of the present invention produce a greater flow and can run more sprinkler heads on the same line, which would mean using fewer valves and using fewer stations on a time clock for a more cost effective system. If the currently used fittings were cut off and replaced with the fittings of the present invention more water could be sprayed in less time, plus providing better water coverage. This all is cost effective and creates less wear on pump motors, uses fewer valves, uses less electricity, and requires less work to install

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a plan view of an intersection of in-ground trenches having intersecting straight water pipes showing a larger diameter smooth flow stretched elbow connector of the present invention in cross-section;

FIG. 2 is a plan view of an intersection of in-ground trenches having intersecting straight water pipes showing a smaller diameter smooth flow stretched elbow connector of the present invention in cross-section;

FIG. 3 is a plan view of an intersection of in-ground trenches having intersecting straight water pipes showing a larger diameter smooth flow curved Y connector of the present invention in cross-section;

FIG. 4 is a plan view of an intersection of in-ground trenches having intersecting straight water pipes showing a smaller diameter smooth flow curved Y connector of the present invention in cross-section;

FIG. 5 is a plan view of an intersection of in-ground trenches having intersecting straight water pipes showing a larger diameter smooth flow curved T connector of the present invention in cross-section;

FIG. 6 is a plan view of an intersection of in-ground trenches having intersecting straight water pipes showing a smaller diameter smooth flow curved T connector of the present invention in cross-section.

### BEST MODE FOR CARRYING OUT THE INVENTION

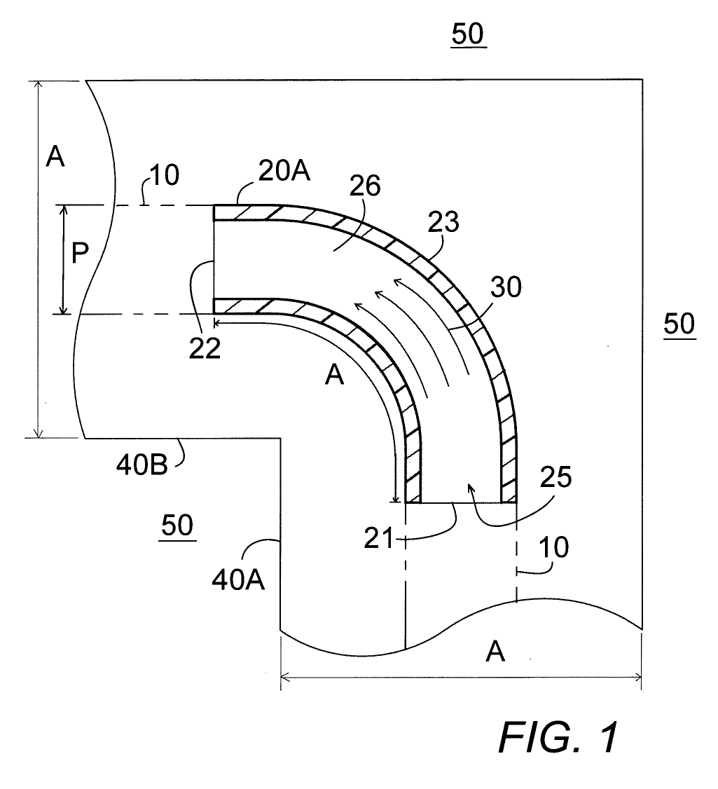

In FIGS. 1-6, a pipe connector 20A-20F interconnects intersecting straight pipes 10 in an underground grid pattern sprinkler system set into four-inch wide trenches 40 in a ground surface 50. The pipe connector 20A-20F is preferably fabricated of PVC bent to form the curved section.

The pipe connector 20A-20F comprises a first open end 21 adapted to connect to a straight section of same diameter pipe 10 in a center of a first in-ground trench 40A of width A, which is preferably four inches, at least one second open end 22, 22A and 22B adapted to connect to a straight section of same diameter pipe 10 in a center of a second in-ground trench 40B having a same width as a first in-ground trench and intersecting a first in-ground trench at a right angle, a curved section 23 between the first and second open ends, the curved section configured in a maximum length of curve A to fit between two four-inch perpendicular trenches with the straight pipes and the connectors positioned in the center of the trenches. The pipe connector 20A-20F has an internal passageway 25 from the first open end 21 to the second open end 22 communicating with the open ends, the internal passageway having a smooth peripheral wall 26 at least the same diameter as a mating straight pipe along its entire length, the internal passageway adapted to maintain a smooth flow of water therethrough at the same water pressure as that of a straight pipe feeding into the internal passageway.

The curved section 23 is configured in a length of curve A from the first open end 21 to the second open end 22 at least equal to a width A, normally four inches, of each of a pair of intersecting trenches 40A and 40B within which the pipe connector is positioned, the curved section 23 being sufficiently shallow in angle and sufficiently long to maintain a smooth laminar flow of water 30 through the pipe connector between the open ends at a constant pressure.

The open ends 21 and 22 comprise a size of opening compatible with PVC pipes used in underground sprinkler systems including half inch pipe, three-quarter inch pipe, one inch pipe, one and one-quarter inch pipe, one and one-half inch pipe, one and three-quarter inch pipe and two inch pipe.

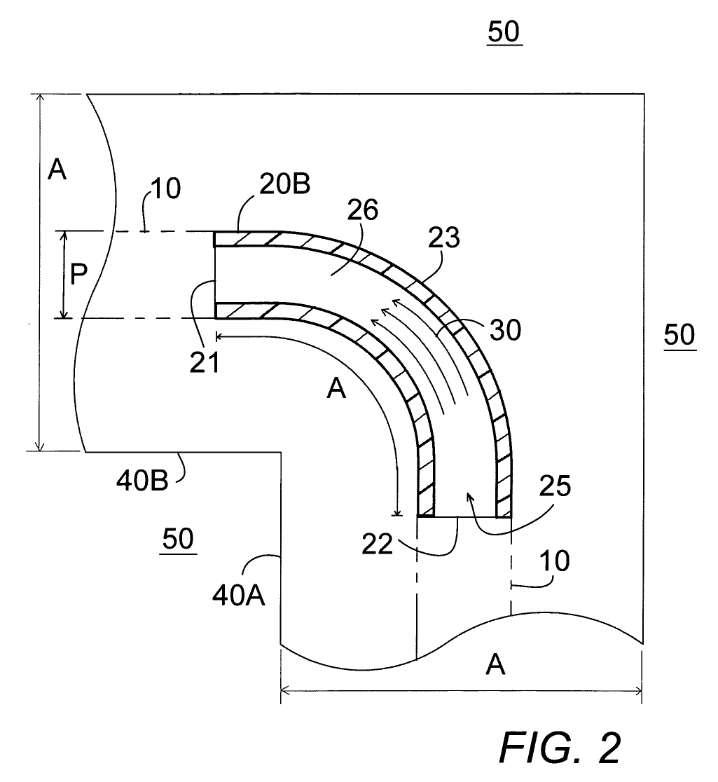

In FIGS. 1 and 2, the pipe connector 20A and 20B is formed in a shape of a smooth flow stretched elbow pipe connector having a single second open end 22. In FIG. 1, the size of the pipe P is larger than in FIG. 2.

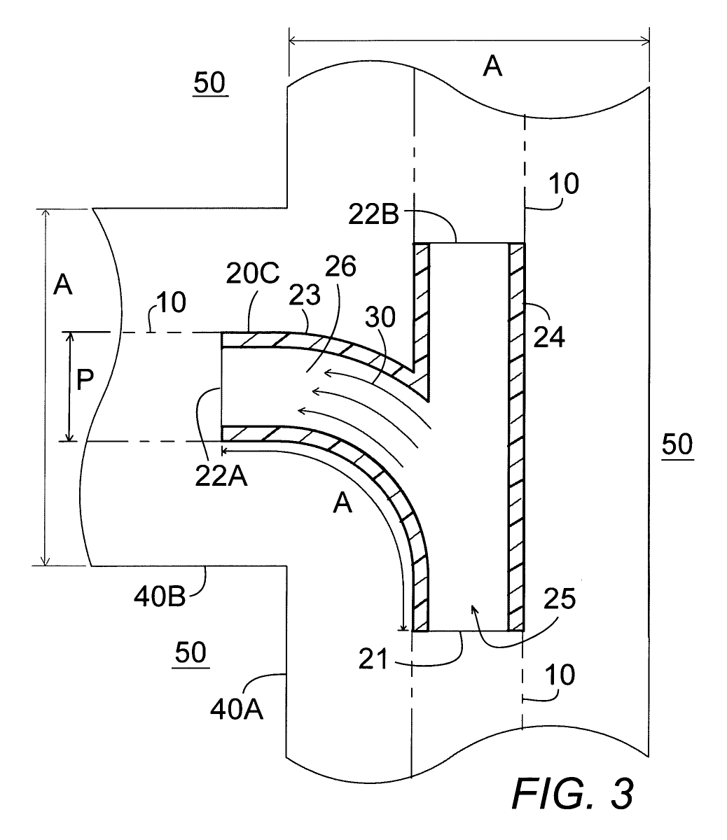

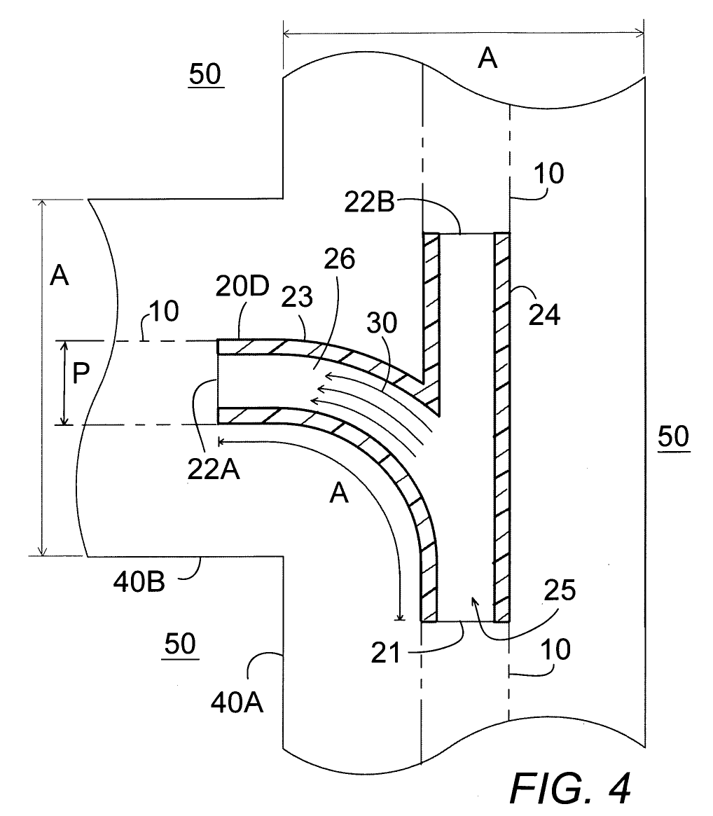

In FIGS. 3 and 4, the pipe connector 20B and 20C is formed in a shape of a curved Y-shaped pipe connector 20B and 20C having a smooth flow curved section 23 with a smooth laminar flow of water 30 stemming from a first open end 21 and converging with an adjacent attached straight section 24 with two second open ends 22A and 22B each attachable to an aligned straight pipe 10.

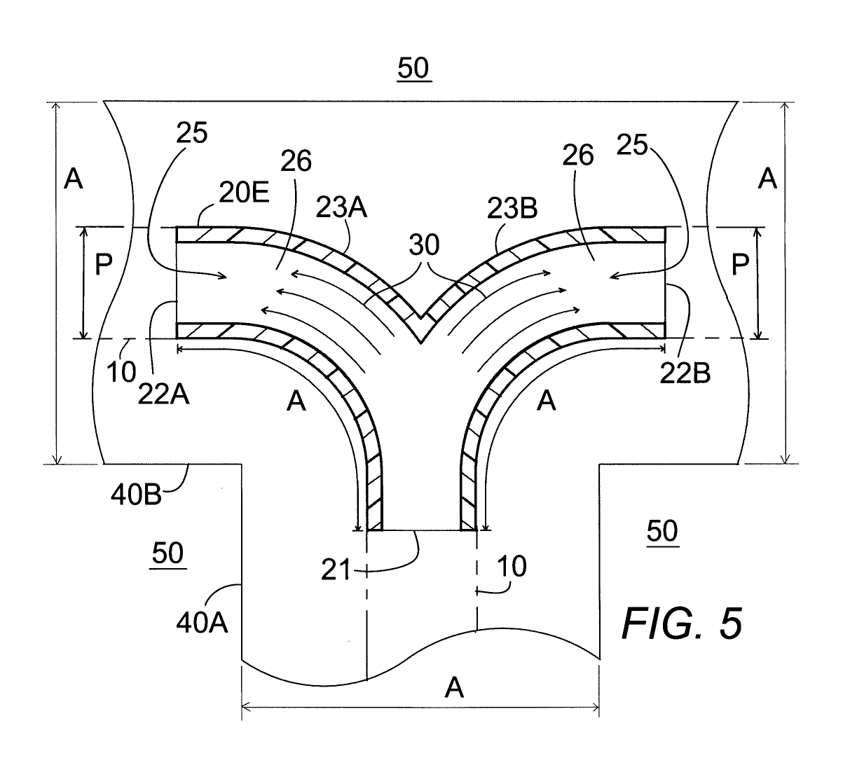

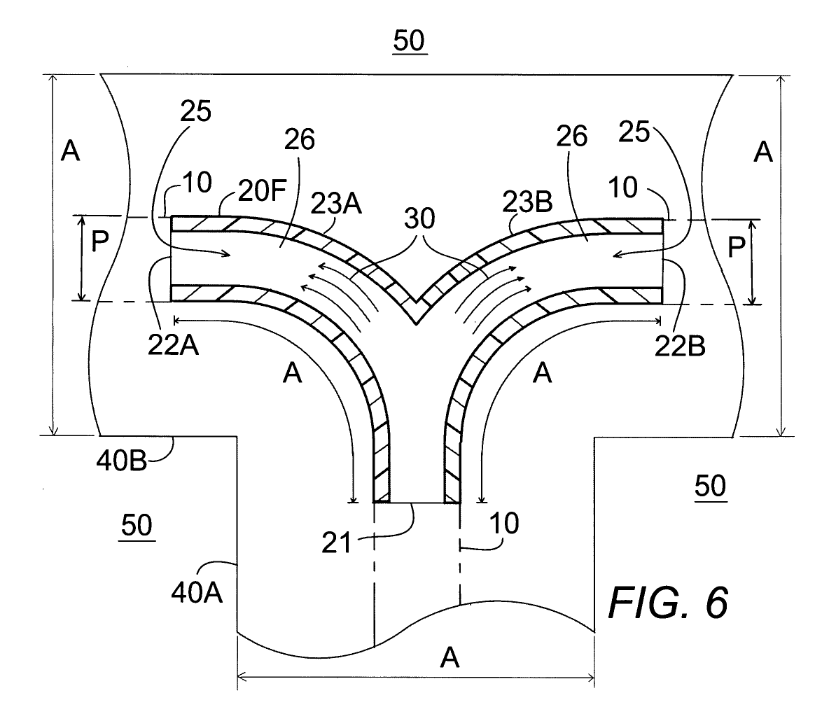

In FIGS. 5 and 6, the pipe connector 20E and 20F is formed in a shape of a curved T-shaped pipe connector having two second open ends 22A and 22B and two smooth flow curved sections 23A and 23B, each of the two smooth flow curved sections stemming from a first open end 21 and extending to each of the two second open ends 22A and 22B connecting to straight pipes 10, with a smooth laminar flow of water 30 through the curved sections.

It is understood that the preceding description is given merely by way of illustration and not in limitation of the invention and that various modifications may be made thereto without departing from the spirit of the invention as claimed.

1. A pipe connecting device to interconnect intersecting straight pipes in an underground grid pattern sprinkler system, the device comprising:
a pipe connector comprising a first open end adapted to connect to a straight section of same diameter pipe in a center of a first in-ground trench, at least one second open end adapted to connect to a straight section of same diameter pipe in a center of a second in-ground trench having a same width as a first in-ground trench and intersecting a first in-ground trench at a right angle, a curved section of pipe between the first and second open ends, the curved section of pipe configured in a maximum length of curve to fit between two perpendicular trenches each having the same width with a straight pipe positioned in the center in each of the trenches, the pipe connector having an internal passageway from the first open end to the second open end communicating with the open ends, the internal passageway having a smooth peripheral wall at least the same diameter as a mating straight pipe along its entire length, the internal passageway adapted to maintain a smooth flow of water therethrough at the same water pressure as that of a straight pipe feeding into the internal passageway.

2. The device of claim 1 wherein the curved section of pipe is configured in a length of curve sufficiently shallow in angle and sufficiently long to maintain a flow of water through the pipe connector between the open ends at a constant pressure.

3. The device of claim 1 wherein the curved section of pipe is configured in a length of curve sufficiently shallow in angle and sufficiently long to allow a smooth laminar flow of water through the pipe connector between the open ends.

4. The device of claim 1 wherein the pipe connector has a length from the first open end to the second open end at least equal to a width of each of a pair of intersecting trenches within which the pipe connector is positioned.

5. The device of claim 4 wherein the pipe connector is adapted to be used in a pair of orthogonally intersecting trenches each having a width of four inches and the length of the pipe connector from the first open end to the second open end is at least four inches.

6. The device of claim 5 wherein the open ends comprise a size of opening compatible with PVC pipes used in underground sprinkler systems including half inch pipe, three-quarter inch pipe, one inch pipe, one and one-quarter inch pipe, one and one-half inch pipe, one and three-quarter inch pipe and two inch pipe.

7. The device of claim 1 wherein the pipe connector is formed in a shape of a smooth flow stretched elbow pipe connector having a single second open end.

8. The device of claim 1 wherein the pipe connector is formed in a shape of a curved Y-shaped pipe connector having a smooth flow curved section stemming from a first open end and converging with an adjacent attached straight section with two second open ends each attachable to an aligned straight pipe.

9. The device of claim 1 wherein the pipe connector is formed in a shape of a curved T-shaped pipe connector having two second open ends and two smooth flow curved sections, each of the two smooth flow curved sections stemming from a first open end and extending to each of the two second open ends.

10. The device of claim 1 wherein the pipe connector is fabricated of PVC bent to form the curved section.
